(19) United States
(12) Patent Application Publication
(10) Pub. No.: US 2016/0373498 A1
(43) Pub. Date: Dec. 22, 2016

(54) MEDIA-TIMED WEB INTERACTIONS

(71) Applicant: QUALCOMM Incorporated, San Diego, CA (US)

(72) Inventors: Giridhar Dhati Mandyam, San Diego, CA (US); Charles Nung Lo, San Diego, CA (US); Gordon Kent Walker, Poway, CA (US); Thomas Stockhammer, Bergen (DE)

(21) Appl. No.: 15/185,676

(22) Filed: Jun. 17, 2016

Related U.S. Application Data
(60) Provisional application No. 62/181,700, filed on Jun. 18, 2015.

(51) Int. Cl. H04L 29/06; H04L 29/08

(52) U.S. Cl. CPC H04L 65/4092; H04L 67/02

(57) ABSTRACT

An example method of rendering media content includes receiving, at a client application executing on a computing device, streaming media content. The method also includes identifying a plurality of tracks associated with the media content. The plurality of tracks includes a DOM track specifying one or more user interface (UI) events to execute at a set of time intervals, and the set of time intervals corresponds to a timeline in accordance with the streaming media content. The method further includes rendering the DOM track in accordance with the timeline of the streaming media content.

### CROSS REFERENCE TO RELATED APPLICATIONS

The present application claims priority to and the benefit of U.S. Provisional Patent Application No. 62/181,700, filed Jun. 18, 2015, which is hereby incorporated by reference in its entirety.

### FIELD OF DISCLOSURE

The present disclosure generally relates to streaming media content, and more particularly to providing user interaction that is timed with the streaming media content.

### BACKGROUND

A media content provider or distributor may stream media content to streaming clients, which may take the form of various user end devices, such as televisions, notebook computers, and mobile handsets. Media content may be delivered from a streaming server to a streaming client adaptively based on a variety of factors, such as network conditions, device capability, and user choice. Upon reception of the transport system (TS), the streaming client may parse the TS to extract information from within. Adaptive streaming technologies may include various technologies or standards implemented or being developed, such as Dynamic Adaptive Streaming over Hypertext Transfer Protocol (HTTP) (DASH), HTTP Live Streaming (HLS), Adaptive Transport Streaming (ATS), or Internet Information Services (IIS) Smooth Streaming.

For example, as one type of adaptive streaming, DASH has been defined by the International Organization for Standardization (ISO) and the International Electrotechnical Commission (IEC) in an international standard. The standard, usually identified as ISO/IEC 23009-1, is entitled “Information technology—Dynamic adaptive streaming over HTTP (DASH)—Part 1: Media presentation description and segment formats.”

### BRIEF SUMMARY

According to some embodiments, a method of rendering media content includes receiving, at a client application executing on a computing device, streaming media content; identifying a plurality of tracks associated with the media content, the plurality of tracks including a Document Object Model (DOM) track specifying one or more User Interface (UI) events to execute at a set of time intervals, and the set of time intervals corresponding to a timeline in accordance with the streaming media content; and rendering the DOM track in accordance with the timeline of the streaming media content.

According to some embodiments, a system for rendering media content includes a network interface that receives streaming media content. The system also includes a streaming media player coupled to the network interface. The streaming media player identifies a plurality of tracks associated with the media content and renders a DOM track in accordance with a timeline of the streaming media content. Additionally, the plurality of tracks includes the DOM track. The DOM track specifies one or more UI events to execute at a set of time intervals, and the set of time intervals corresponds to the timeline.

According to some embodiments, a machine-readable medium includes a plurality of machine-readable instructions that when executed by one or more processors is adapted to cause the one or more processors to perform a method including: receiving, at a client application executing on a computing device, streaming media content; identifying a plurality of tracks associated with the media content, the plurality of tracks including a DOM track specifying one or more UI events to execute at a set of time intervals, and the set of time intervals corresponding to a timeline in accordance with the streaming media content; and rendering the DOM track in accordance with the timeline of the streaming media content.

According to some embodiments, an apparatus for rendering media content includes means for receiving streaming media content. The apparatus also includes means for identifying a plurality of tracks associated with the media content. The plurality of tracks includes a DOM track specifying one or more UI events to execute at a set of time intervals. The set of time intervals corresponds to a timeline in accordance with the streaming media content. The apparatus further includes means for rendering the DOM track in accordance with the timeline of the streaming media content.

According to some embodiments, a method of generating a DOM track associated with media content includes receiving a set of time intervals. Each time interval has start and end times corresponding to a timed playback of streamable media content. The method also includes determining one or more UI events to execute for each time interval of the set of time intervals. The method further includes generating a DOM track specifying the determined one or more UI events to execute for each time interval of the set of time intervals.

According to some embodiments, a system for generating a DOM track associated with media content includes a streaming server that receives a set of time intervals. Each time interval has start and end times corresponding to a timed playback of streamable media content. The streaming server determines one or more UI events to execute for each time interval of the set of time intervals. The streaming server generates a DOM track specifying the determined one or more UI events to execute for each time interval of the set of time intervals.

According to some embodiments, a machine-readable medium includes a plurality of machine-readable instructions that when executed by one or more processors is adapted to cause the one or more processors to perform a method including receiving a set of time intervals, each time interval having start and end times corresponding to a timed playback of streamable media content; determining one or more UI events to execute for each time interval of the set of time intervals; and generating a DOM track specifying the determined one or more UI events to execute for each time interval of the set of time intervals.

According to some embodiments, an apparatus for generating a DOM track associated with media content includes means for receiving a set of time intervals. Each time interval has start and end times corresponding to a timed playback of streamable media content. The apparatus also includes means for determining one or more UI events to execute for each time interval of the set of time intervals. The apparatus further includes means for generating a DOM track specifying the determined one or more UI events to execute for each time interval of the set of time intervals.

### BRIEF DESCRIPTION OF THE DRAWINGS

The accompanying drawings, which form a part of the specification, illustrate embodiments of the invention and together with the description, further serve to explain the principles of the embodiments. In the drawings, like reference numbers may indicate identical or functionally similar elements. The drawing in which an element first appears is generally indicated by the left-most digit in the corresponding reference number.

FIG. 1 is a block diagram illustrating a system for rendering media content in accordance with some embodiments.

FIG. 2 is a block diagram illustrating a process flow for generating a DOM track in accordance with some embodiments.

FIG. 3 is an example of a UI event specified in a DOM track including a layout that is restricted to the video viewport in accordance with some embodiments.

FIG. 4 is an example of a UI event specified in a DOM track including a layout that is not restricted to the video viewport in accordance with some embodiments.

FIG. 5 is a block diagram illustrating a process flow for streaming media content in accordance with some embodiments.

FIG. 6 is a simplified flowchart illustrating a method of rendering media content in accordance with some embodiments.

FIG. 7 is a simplified flowchart illustrating a method of generating a DOM track associated with media content in accordance with some embodiments.

FIG. 8 is a block diagram illustrating a wireless device including a digital signal processor, according to some embodiments.

### DETAILED DESCRIPTION

### I. Overview

### II. Example System Architecture

### III. Example Methods

### VI. Example Computing System

### I. Overview

It is to be understood that the following disclosure provides many different embodiments, or examples, for implementing different features of the present disclosure. Some embodiments may be practiced without some or all of these specific details. Specific examples of components, modules, and arrangements are described below to simplify the present disclosure. These are, of course, merely examples and are not intended to be limiting.

In some embodiments, a method of rendering media content includes receiving, at a client application executing on a computing device; streaming media content; identifying a plurality of tracks associated with the media content, the plurality of tracks including a DOM track specifying one or more user interface (UI) events to execute at a set of time intervals, and the set of time intervals corresponding to a timeline in accordance with the streaming media content; and rendering the DOM track in accordance with the timeline of the streaming media content.

### II. Example System Architecture

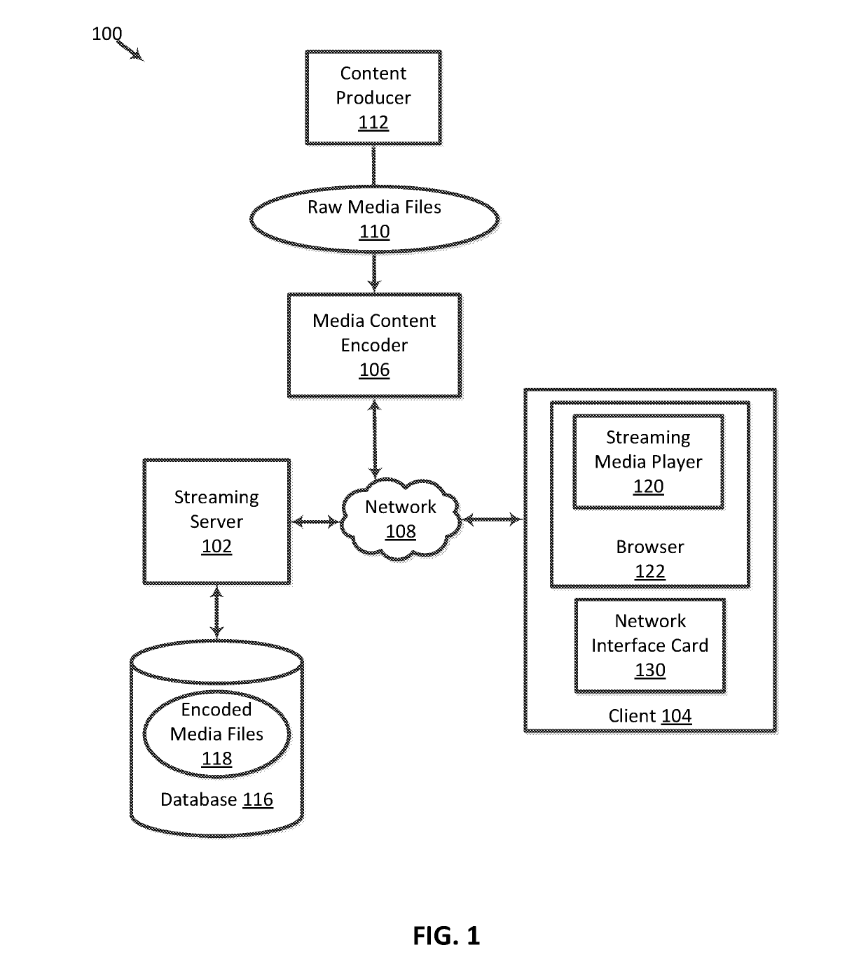

FIG. 1 is a block diagram illustrating a system 100 for rendering media content in accordance with some embodiments. System 100 includes a streaming server 102, client 104, and media content encoder 106 coupled over a network 108. Although one streaming server, one client, and one media content encoder are illustrated, this is not intended to be limiting, and system 100 may include one or more streaming servers, clients, and/or media content encoders.

Network 108 may be a private network (e.g., local area network (LAN), wide area network (WAN), intranet, etc.), a public network (e.g., the Internet), or a combination thereof. The network may include various configurations and use various protocols including the Internet, World Wide Web, intranets, virtual private networks, wide area networks, local networks, private networks using communication protocols proprietary to one or more companies, cellular and other wireless networks, Internet relay chat channels (IRC), instant messaging, simple mail transfer protocols (SMTP), Ethernet, WiFi and HTTP, and various combinations of the foregoing.

System 100 may provide a user of client 104 with rich Web interactions. Streaming server 102, client 104, and media content encoder 106 communicate with each other using specific protocols, and exchange files in particular formats. Some files contain data that has been encoded using a particular codec, which is designed to reduce the size of files. A content provider 112 may provide raw media files 110 to media content encoder 106 for encoding. Media content encoder 106 converts raw media files 110 (e.g., audio and video files) into a format that can be streamed across network 108. Content producer 112 may be a human being or a computing device. After media content encoder 106 encodes raw media files 110, media content encoder 106 may send the encoded media files to streaming server 102 for storage in database 116. Media content encoder 106 may create the media content streams that are stored in database 116 and that are accessible by streaming server 102.

Client 104 includes a network interface 130, streaming media player 120, and browser 122. Although streaming media player 120 is illustrated as being incorporated in browser 122, this is not intended to be limiting and it should be understood that streaming media player 120 and browser 122 may be separate components that interact with each other. Streaming media player 120 is a client application that is capable of rendering media content streams. The media content may be requested by client 104 and received from streaming server 102, which may be a specialized piece of software designed to deliver media content streams. Client 104 may be any client device such as a hand-held telephone (e.g., smartphone), personal digital assistant (PDA), tablet, desktop, or laptop. Other devices are within the scope of the present disclosure.

Encoded media files 118 may be an encoded and streamable version of raw media files 110. Encoded media files 118 are in a streaming format that may be sent to client 104 and streamed by client 104. In some examples, encoded media files 118 are packaged into a media file that includes a plurality of tracks. The plurality of tracks may include a video track having video data, an audio track having audio data, etc.

In some examples, content producer 112 may perform further processing on encoded media files 118 (or on raw media files 110) to produce additional tracks. For example, content producer 112 may produce a closed captioning track having closed captioning data associated with video and/or audio tracks, a document object model (DOM) track having DOM track data associated with video and/or audio tracks, or other tracks. A DOM track may refer to a collection of data that describes Web user interface (UI) events that are timed in accordance with the playback of the streaming media content. In an example, content producer 112 may desire to have certain events occur while media content is being streamed at client 104. Additionally, content producer 112 may desire to have the events occur in synchronization with a timed playback of the streaming media content, and may accomplish this by generating a DOM track.

In an example, a DOM track is stored in an International Organization for Standardization (ISO) Base Media File Format (BMFF). In this example, the DOM track may be announced in a movie header as a separate track. An ISO BMFF initialization segment may be defined as a single File Type Box (ftyp) followed by a single movie header box (moov). In another example, a DOM track is distributed as a representation in Dynamic Adaptive Streaming over Hypertext Transfer Protocol (DASH). One or more representations (i.e., versions at different resolutions or bit rates) of multimedia files may be available, and representation selection may be based on various factors, such as network conditions, device capabilities, and user preferences. In this example, the DOM track may be signaled in a media presentation description (MPD) file as a separate adaptation set for client selection. An adaption set contains one or more media content streams. A representation allows an adaptation set to contain the same content encoded in different ways. In another example, a DOM track is distributed as an asset in Moving Picture Experts Group (MPEG) Media Transport (MMT). In another example, a DOM track is distributed as an asset in MMT. In another example, a DOM track is distributed as an elementary stream in an MPEG-2 transport stream.

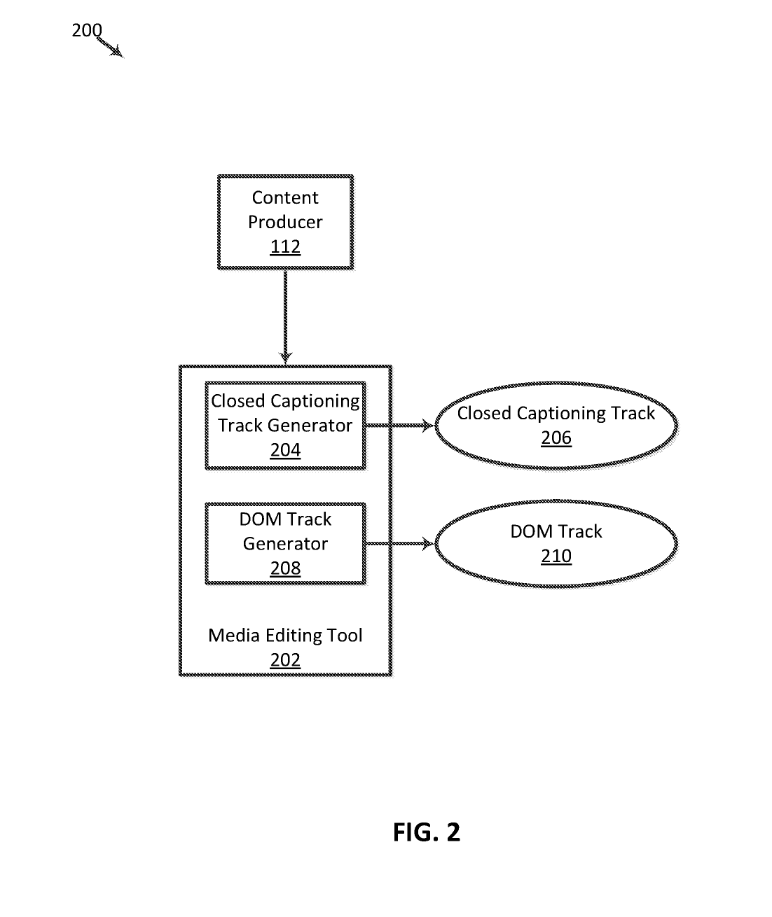

FIG. 2 is a block diagram illustrating a process flow 200 for generating a DOM track in accordance with some embodiments. FIG. 2 includes a media editing tool 202 that generates one or more tracks. In some examples, the one or more tracks generated by media editing tool 202 are included in encoded media files 118. Media editing tool 202 includes a closed captioning track generator 204 that generates closed captioning track 206 associated with a video track and/or audio track. Media editing tool 202 also includes a DOM track generator 208 that generates DOM track 210 associated with the video track and/or audio track. Closed captioning track 206 may be a track that is separate from DOM track 210.

Content producer 112 may provide to media editing tool 202 a set of time intervals corresponding to a timed playback of media content in a streaming format along with one or more UI events to execute for each time interval of the set of time intervals. A UI event may correspond to a time interval if the UI event is to be executed during that time interval. In some examples, the UI events are executed in the context of a webpage at the corresponding time interval. Media editing tool 202 may receive a set of time intervals, where each time interval has start and end times corresponding to a timed playback of streamable media content that will be provided to the client. Media editing tool 202 may determine one or more UI events to execute for each time interval of the set of time intervals, and generate a DOM track 210 specifying the determined one or more UI events to execute for each time interval of the set of time intervals.

A UI event is executed in accordance with a timed playback of the streamable media content. The set of time intervals specified in DOM track 210 corresponds to a timed playback of a video track and/or an audio track associated with the streamable media content. The times corresponding to a UI event and specified in DOM track 210 follow a timeline of the video track and/or an audio track associated with DOM track 210. For example, content producer 112 may desire a UI event to occur (e.g., display popup in the same or a different webpage that the video track is being rendered) during a time interval having a start time of 11 seconds and an end time of 13 seconds in the streamable media content. In this example, the UI event is executed while the video track is being rendered at time 11-13 seconds.

A UI event specified in DOM track 210 may be defined in a variety of ways. In some examples, a UI event is executed by executing a web code snippet that is timed in accordance with the streamable media content. In an example, a UI event is defined using HyperText Markup Language (HTML). In another example, a UI event is defined using JAVASCRIPT®. Trademarks are the properties of their respective owners.

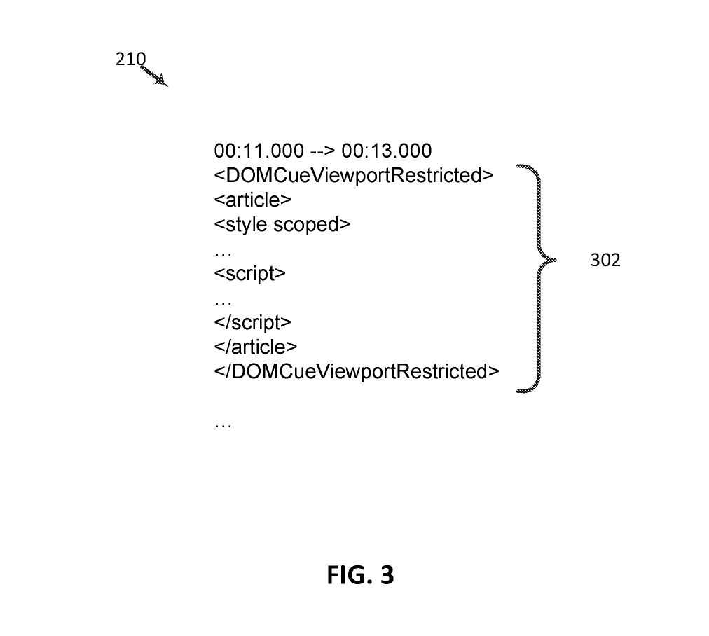

In some examples, a UI event is executed in the context of a webpage displayed at client 104. In an example, the UI event is restricted to the video “viewport” at client 104. In this example, an object (e.g., image, popup, text, etc.) may be superimposed over the video that is being played at client 104. A UI event may be executed within a video viewport that displays the video track. FIG. 3 is an example of a UI event specified in a DOM track including a layout that is restricted to the video viewport in accordance with some embodiments. In the example illustrated in FIG. 3, a UI event 302 is enclosed within the <DOMCueViewportRestricted> and </DOMCueViewportRestricted> tags, and UI event 302 is defined using JAVASCRIPT®. Streaming media player 120 at client 104 may know to execute UI event 302 within the video viewport because UI event 302 is enclosed within the <DOMCueViewportRestricted> and </DOMCueViewportRestricted> tags.

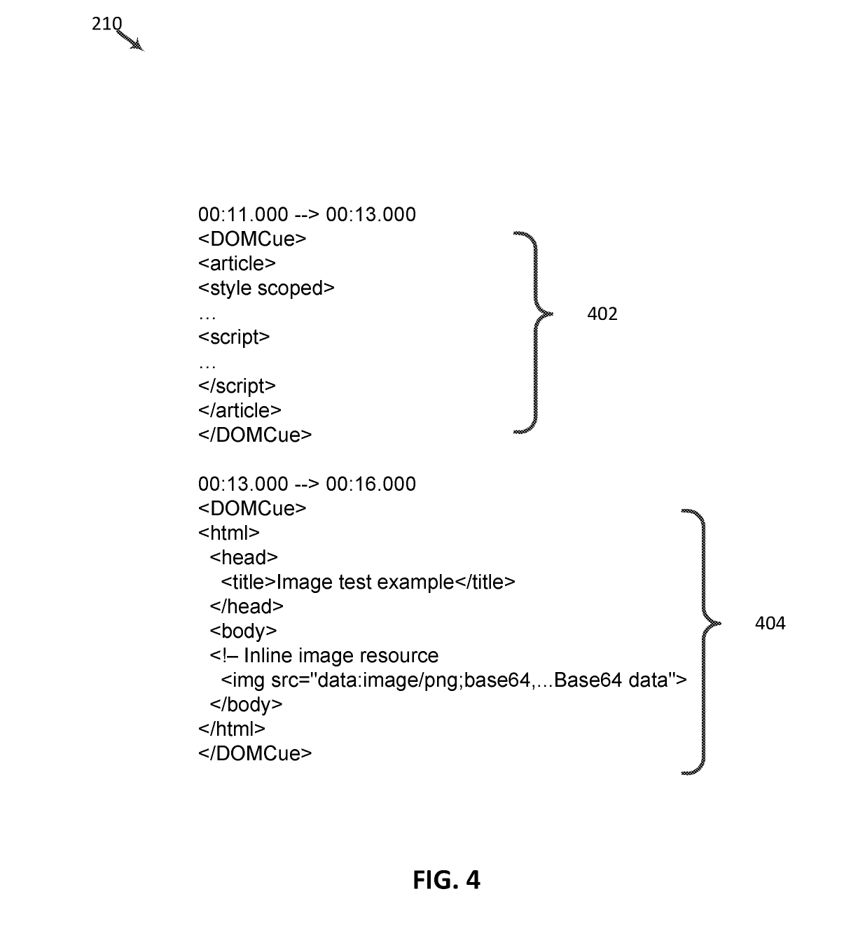

In another example, the UI event is not restricted to the video viewport, and the object is not superimposed over the video. In an example, a dialogue box including “Press OK if you would like more information about this product” is displayed at client 104 (e.g., via streaming media player 120). If the user selects the “OK” option in the dialogue box, browser 122 may open up a new tab that takes the user to the product webpage, where the user may obtain more information about the product. Providers of goods or services, for example, may desire to provide more information about their offerings in order to increase business and/or provide users with more information about their products. A UI event may be executed outside of the video viewport that displays the video track. FIG. 4 is an example of a UI event specified in a DOM track including a layout that is not restricted to the video viewport in accordance with some embodiments. In the example illustrated in FIG. 4, UI events 402 and 404 are enclosed within the <DOMCue> and </DOMCue> tags. UI event 402 is defined using JAVASCRIPT®, and UI event 404 is defined using HTML. An HTML document is embedded in the <DOMCue> and </DOMCue> tags of UI event 404. Streaming media player 120 at client 104 may know to execute UI events 402 and 404 outside of the video viewport because UI events 402 and 404 are enclosed within the <DOMCue> and </DOMCue> tags.

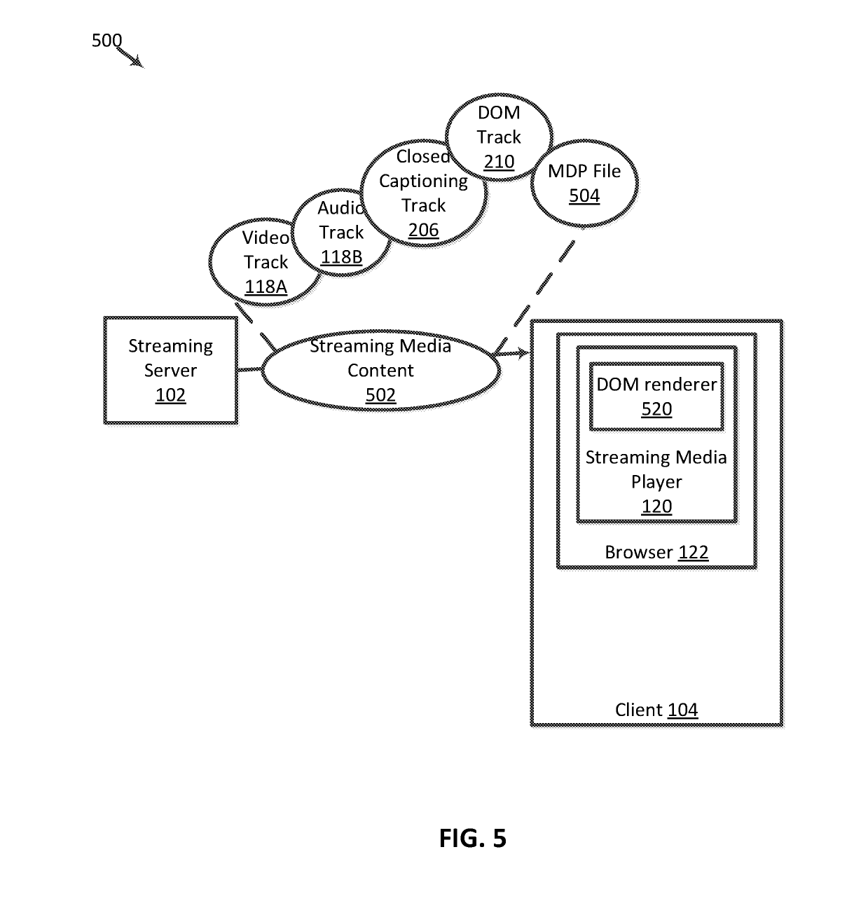

Streaming server 102 may stream media content to streaming clients, which may take the form of various end-user devices, such as televisions, notebook computers, and mobile handsets, among other devices. FIG. 5 is a block diagram illustrating a process flow 500 for streaming media content 502 in accordance with some embodiments. In FIG. 5, streaming server 102 sends streaming media content 502, which may include several media components, to client 104. In FIG. 5, streaming media content 502 includes a plurality of tracks including a video track 118A, audio track 118B, closed captioning track 206, and DOM track 210. In some examples, streaming media content 502 also includes a media presentation description (MDP) file 504 that provides a list of tracks included in streaming media content 502. MPD file 504 may be an extensible markup language (XML) file or document describing streaming media content 502, such as its various representations, Uniform Resource Locator (URL) addresses from which the files and associated information may be retrieved, and other characteristics. Each of the tracks included in streaming media content 502 may have different characteristics that are specified in MPD file 504.

Network interface 130 receives data over network 108, and transmits data over network 108. In some examples, network interface 130 receives streaming media content 502 and passes it to streaming media player 120. Streaming media player 120 processes streaming media content 502. MDP file 504 provides streaming media player 120 with information on video track 118A and its location, audio track 118B and its location, closed captioning track 206 and its location, and DOM track 210 and its location. Streaming media player 120 may stream video track 118A, audio track 118B, and closed captioning track 206, and DOM track 210.

Streaming media player 120 includes a DOM renderer 520 that processes and streams DOM track 210. DOM renderer 520 parses and renders DOM track 210, which is timed with video track 118A, audio track 118B, and/or closed captioning track 206. DOM renderer 520 streams DOM track 210 in accordance with the set of time intervals specified in the track. For example, DOM renderer 520 parses and interprets DOM track 210, and recognizes the commands in DOM track 210 by the particular tags (e.g., <DOMCue> and </DOMCue> tags, <DOMCueViewportRestricted> and </DOMCueViewportRestricted> tags, etc.).

In some embodiments, DOM renderer 520 identifies a plurality of tracks associated with streaming media content 502. In FIG. 5, the plurality of tracks includes DOM track 210, which specifies one or more UI events to execute at a set of time intervals, and the set of time intervals corresponds to a timeline in accordance with the streaming media content. In some examples, the UI events are executed in one or more webpages. Each time interval has start and end times corresponding to a timed playback of the streamable media content. DOM renderer 520 renders DOM track 210 in accordance with the timeline of the streaming media content.

In some examples, browser 122 includes a video tag that is a DOM element. A webpage that is displayed by browser 122 may pass DOM track 210 to the video tag for processing. In some examples, streaming media player 120 is browser 122's native media player.

DOM renderer 520 executes the UI events specified in DOM track 210 at their corresponding time intervals. For example, in reference to FIG. 3, DOM renderer 520 may execute UI event 302 during a time interval having a start time of 11 seconds and an end time of 13 seconds during the streaming of media content 502. UI event 302 is timed in accordance with a timeline of streaming media content 502. For example, the start and ends times are different points of time in audio track 118A and/or audio track 118B.

DOM renderer 520 executes the UI events, which are in the form of web code snippets (e.g., HTML, JAVASCRIPT, etc.). The UI events are timed with video track 118A, audio track 118B, and/or closed captioning track 206. In some examples, streaming media player 120 displays objects (e.g., popups, dialog boxes, etc.), where the objects are timed with streaming media content 502 in the context of webpages.

### III. Example Methods

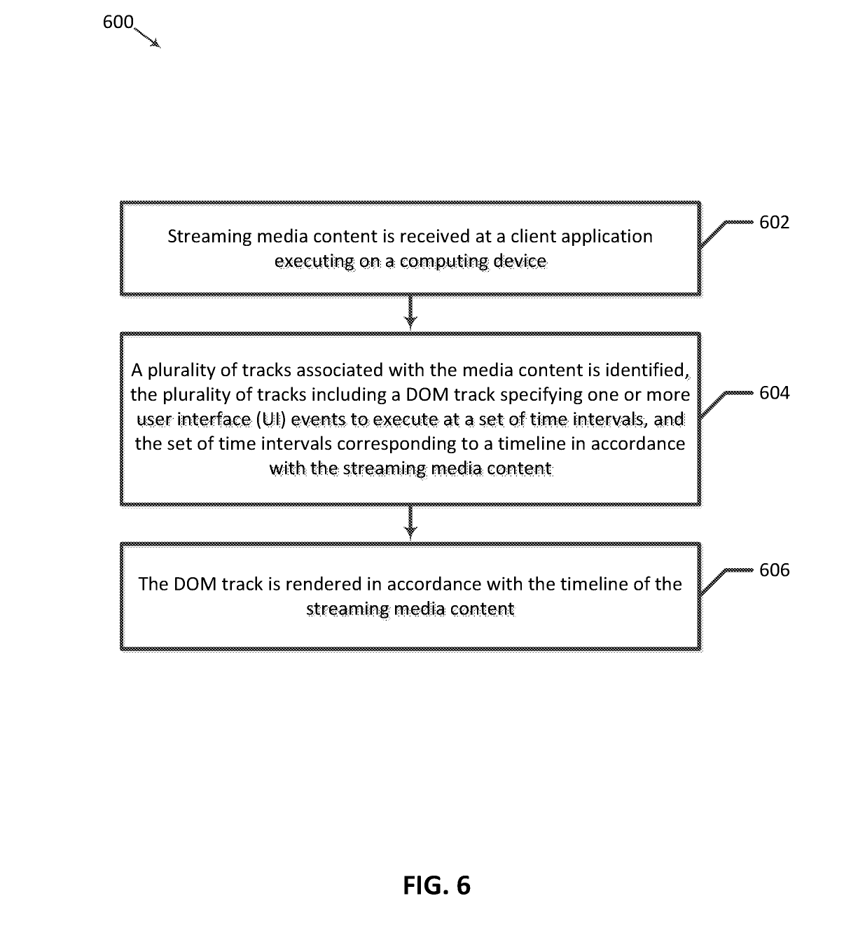

FIG. 6 is a simplified flowchart illustrating a method 600 of rendering media content in accordance with some embodiments. Method 600 is not meant to be limiting and may be used in other applications.

Method 600 includes blocks 602-606. In a block 602, streaming media content is received at a client application executing on a computing device. In a block 604, a plurality of tracks associated with the media content is identified, the plurality of tracks including a DOM track specifying one or more UI events to execute at a set of time intervals, and the set of time intervals corresponding to a timeline in accordance with the streaming media content. In a block 606, the DOM track is rendered in accordance with the timeline of the streaming media content.

It is also understood that additional processes may be performed before, during, or after blocks 602-606 discussed above. It is also understood that one or more of the blocks of method 600 described herein may be omitted, combined, or performed in a different sequence as desired.

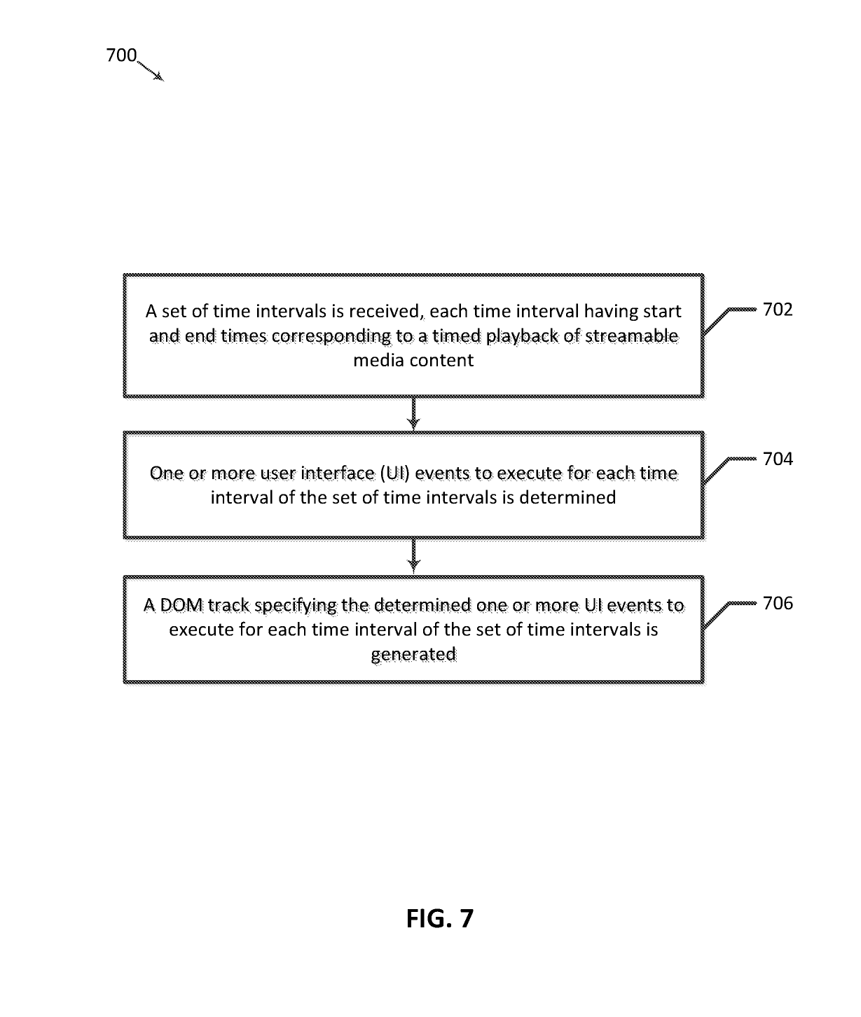

FIG. 7 is a simplified flowchart illustrating a method 700 of generating a DOM track associated with media content in accordance with some embodiments. Method 700 is not meant to be limiting and may be used in other applications.

Method 700 includes blocks 702-706. In a block 702, a set of time intervals is received, each time interval having start and end times corresponding to a timed playback of streamable media content. In a block 704, one or more user interface (UI) events to execute for each time interval of the set of time intervals is determined In a block 706, a DOM track specifying the determined one or more UI events to execute for each time interval of the set of time intervals is generated.

It is also understood that additional processes may be performed before, during, or after blocks 702-706 discussed above. It is also understood that one or more of the blocks of method 700 described herein may be omitted, combined, or performed in a different sequence as desired.

As discussed above and further emphasized here, FIGS. 1-7 are merely examples, which should not unduly limit the scope of the claims.

### IV. Example Computing System

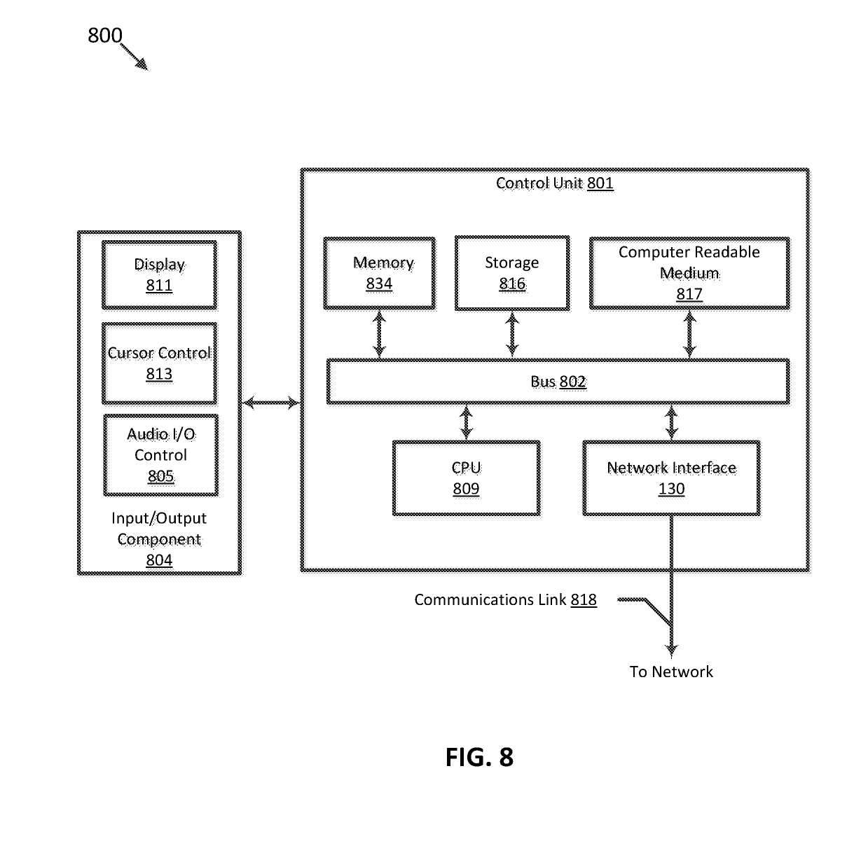

FIG. 8 is a block diagram of an example computer system 800 suitable for implementing any of the embodiments disclosed herein. In various implementations, computer system 800 may be client 104 or a computing device on which streaming server 102 executes. Computer system 800 includes a control unit 801 coupled to an input/output (I/O) 804 component.

Control unit 801 may include one or more CPUs 809 and may additionally include one or more storage devices each selected from a group including floppy disk, flexible disk, hard disk, magnetic tape, any other magnetic medium, CD-ROM, any other optical medium, random access memory (RAM), programmable read-only memory (PROM), erasable ROM (EPROM), FLASH-EPROM, any other memory chip or cartridge, and/or any other medium from which a processor or computer is adapted to read. The one or more storage devices may include stored information that may be made available to one or more computing devices and/or computer programs (e.g., clients) coupled to computer system 800 using a computer network (e.g., network 108).

Computer system 800 includes a bus 802 or other communication mechanism for communicating information data, signals, and information between various components of computer system 800. Components include I/O component 804 for processing user actions, such as selecting keys from a keypad/keyboard or selecting one or more buttons or links, etc., and sends a corresponding signal to bus 802. I/O component 804 may also include an output component such as a display 811, and an input control such as a cursor control 813 (such as a keyboard, keypad, mouse, etc.). An audio I/O component 805 may also be included to allow a user to use voice for inputting information by converting audio signals into information signals. Audio I/O component 805 may allow the user to hear audio. In an example, a user of client 104 may request streaming media content 502 using cursor control 813 and/or audio I/O component 805. In an example, streaming media player 120 may render audio track 118B using audio I/O component 805.

A transceiver or network interface 130 transmits and receives signals between computer system 800 and other devices (e.g., streaming server 102) via a communication link 818 to a network. In an embodiment, the transmission is wireless, although other transmission mediums and methods may also be suitable. Additionally, display 811 may be coupled to control unit 801 via communications link 818.

CPU 109, which may be a micro-controller, digital signal processor (DSP), or other processing component, processes these various signals, such as for display on display 811 of computer system 800 or transmission to other devices via communication link 818. In an example, streaming media player 120 may render video track 118A onto display 811.

Components of computer system 800 also include a system memory component 814 (e.g., RAM), a static storage component 816 (e.g., ROM), and/or a computer readable medium 817. Computer system 800 performs specific operations by CPU 109 and other components by executing one or more sequences of instructions contained in system memory component 814. Logic may be encoded in computer readable medium 817, which may refer to any medium that participates in providing instructions to CPU 109 for execution. Such a medium may take many forms, including but not limited to, non-volatile media, volatile media, and transmission media. In various implementations, non-volatile media include optical, or magnetic disks, or solid-state drives, volatile media include dynamic memory, such as system memory component 814, and transmission media include coaxial cables, copper wire, and fiber optics, including wires that include bus 802. In an embodiment, the logic is encoded in non-transitory computer readable medium. Computer readable medium 817 may be any apparatus that can contain, store, communicate, propagate, or transport instructions that are used by or in connection with CPU 109. Computer readable medium 817 may be an electronic, magnetic, optical, electromagnetic, infrared, or semiconductor device or a propagation medium, or any other memory chip or cartridge, or any other medium from which a computer is adapted to read. In an example, transmission media may take the form of acoustic or light waves, such as those generated during radio wave, optical, and infrared data communications.

In various embodiments of the present disclosure, execution of instruction sequences (e.g., method 600 and method 700) to practice the present disclosure may be performed by computer system 800. In various other embodiments of the present disclosure, a plurality of computer systems 800 coupled by communication link 818 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also where applicable, the various hardware components and/or software components set forth herein may be combined into composite components including software, hardware, and/or both without departing from the spirit of the present disclosure. Where applicable, the various hardware components and/or software components set forth herein may be separated into sub-components including software, hardware, or both without departing from the spirit of the present disclosure. In addition, where applicable, it is contemplated that software components may be implemented as hardware components, and vice-versa.

Application software in accordance with the present disclosure may be stored on one or more computer readable mediums. It is also contemplated that the application software identified herein may be implemented using one or more general purpose or specific purpose computers and/or computer systems, networked and/or otherwise. Where applicable, the ordering of various blocks described herein may be changed, combined into composite blocks, and/or separated into sub-blocks to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Changes may be made in form and detail without departing from the scope of the present disclosure. Thus, the present disclosure is limited only by the claims.

What is claimed is:

1. A method of rendering media content, comprising:
receiving, at a client application executing on a computing device, streaming media content;
identifying a plurality of tracks associated with the media content, the plurality of tracks including a DOM track specifying one or more user interface (UI) events to execute at a set of time intervals, and the set of time intervals corresponding to a timeline in accordance with the streaming media content; and
rendering the DOM track in accordance with the timeline of the streaming media content.

2. The method of claim 1, wherein the plurality of tracks includes a video track, the method further comprising:
rendering the video track.

3. The method of claim 1, wherein a UI event is executed within a video viewport that displays the video track.

4. The method of claim 1, wherein a UI event is executed outside of a video viewport that displays the video track.

5. The method of claim 1, wherein the plurality of tracks includes an audio track, the method further comprising:
rendering the audio track.

6. The method of claim 1, wherein the plurality of tracks includes a closed captioning track, the method further comprising:
rendering the closed captioning track.

7. The method of claim 1, wherein a UI event is executed in a webpage.

8. The method of claim 1, wherein a UI event is defined in JAVASCRIPT.

9. The method of claim 1, wherein a UI event is defined in HyperText Markup Language (HTML).

10. The method of claim 1, wherein a UI event is enclosed within a video tag.

11. The method of claim 1, wherein the DOM track is stored in an International Organization for Standardization (ISO) Base Media File Format.

12. The method of claim 11, wherein the DOM track is announced in a movie header as a separate track.

13. The method of claim 1, wherein the DOM track is distributed as a representation in Dynamic Adaptive Streaming over Hypertext Transfer Protocol (DASH).

14. The method of claim 13, wherein the DOM track is signaled in a media presentation description (MPD) file as a separate adaptation set for client selection.

15. The method of claim 1, wherein the DOM track is distributed as an asset in Moving Picture Experts Group (MPEG) Media Transport (MMT).

16. The method of claim 1, wherein the DOM track is distributed as an asset in MMT.

17. The method of claim 1, wherein the DOM track is distributed as an elementary stream in an MPEG-2 transport stream.

18. A system for rendering media content, comprising:
a network interface that receives streaming media content; and
a streaming media player coupled to the network interface, wherein the streaming media player identifies a plurality of tracks associated with the media content and renders a document object model (DOM) track in accordance with a timeline of the streaming media content,
wherein the plurality of tracks includes the DOM track, the DOM track specifies one or more user interface (UI) events to execute at a set of time intervals, and the set of time intervals corresponds to the timeline.

19. A machine-readable medium comprising a plurality of machine-readable instructions that when executed by one or more processors is adapted to cause the one or more processors to perform a method comprising:
receiving, at a client application executing on a computing device, streaming media content;
identifying a plurality of tracks associated with the media content, the plurality of tracks including a DOM track specifying one or more user interface (UI) events to execute at a set of time intervals, and the set of time intervals corresponding to a timeline in accordance with the streaming media content; and
rendering the DOM track in accordance with the timeline of the streaming media content.

20. An apparatus for rendering media content, comprising:
means for receiving streaming media content;
means for identifying a plurality of tracks associated with the media content, the plurality of tracks including a DOM track specifying one or more user interface (UI) events to execute at a set of time intervals, and the set of time intervals corresponding to a timeline in accordance with the streaming media content; and
means for rendering the DOM track in accordance with the timeline of the streaming media content.

21. A method of generating a document object model (DOM) track associated with media content, comprising:
receiving a set of time intervals, each time interval having start and end times corresponding to a timed playback of streamable media content;
determining one or more user interface (UI) events to execute for each time interval of the set of time intervals; and
generating a DOM track specifying the determined one or more UI events to execute for each time interval of the set of time intervals.

22. A system for generating a document object model (DOM) track associated with media content, comprising:
a streaming server that receives a set of time intervals, wherein each time interval has start and end times corresponding to a timed playback of streamable media content,
wherein the streaming server determines one or more user interface (UI) events to execute for each time interval of the set of time intervals, and
wherein the streaming server generates a DOM track specifying the determined one or more UI events to execute for each time interval of the set of time intervals.

23. A machine-readable medium comprising a plurality of machine-readable instructions that when executed by one or more processors is adapted to cause the one or more processors to perform a method comprising:
receiving a set of time intervals, each time interval having start and end times corresponding to a timed playback of streamable media content;
determining one or more user interface (UI) events to execute for each time interval of the set of time intervals; and
generating a DOM track specifying the determined one or more UI events to execute for each time interval of the set of time intervals.

24. An apparatus for generating a document object model (DOM) track associated with media content, comprising:
means for receiving a set of time intervals, each time interval having start and end times corresponding to a timed playback of streamable media content;
means for determining one or more user interface (UI) events to execute for each time interval of the set of time intervals; and
means for generating a DOM track specifying the determined one or more UI events to execute for each time interval of the set of time intervals.
